(19) United States
(12) Patent Application Publication
(10) Pub. No.: US 2006/0281491 A1
(43) Pub. Date: Dec. 14, 2006

(54) Wireless remote control device

(75) Inventor: Tzu-Chiang Shih, Taipei (TW)

Correspondence Address: BERKELEY LAW & TECHNOLOGY GROUP, 1700NW 167TH PLACE, SUITE 240, BEAVERTON, OR, 97006, US

(73) Assignee: Primax Electronics Ltd.

(21) Appl. No.: 11/148,922

(22) Filed: Jun. 9, 2005

(30) Foreign Application Priority Data
May 13, 2005 (TW) 094115520

(51) Int. Cl. H04B 1/38; H04M 1/00

(52) U.S. Cl. 455/558

(57) ABSTRACT

A wireless remote control device includes a housing, a power connector, a rechargeable battery, a charging circuit, a button device and a wireless remote control main circuit. The housing has a size smaller than a PC-card slot of the personal computer to be inserted into the PC-card slot. The power connector is electrically connected to a socket of the PC-card slot when the housing is inserted into the PC-card slot. The charging circuit is used for charging the rechargeable battery with the electricity obtained from the portable computer via the power connector. The button device is disposed outside the housing to be actuated by a user. The wireless remote control main circuit is electrically connected to the button device and the rechargeable battery for generating wireless signals to control the portable computer in response to user's actuation with the rechargeable battery serving as a power supply.

### FIELD OF THE INVENTION

The present invention relates to a wireless remote control device, and more particularly to a wireless remote control device for use with a portable computer.

### BACKGROUND OF THE INVENTION

Referring to FIG. 1, a schematic perspective view of a notebook computer 10 is illustrated. The notebook computer 10 has an opening 11 as a PC-card slot. In a case that a PC-card peripheral extensive device such as a memory, a modem, a network and a hard disc is inserted into the PC-card slot 11, the PC-card peripheral extensive device will be electrically connected to the notebook computer 10. The PC-card slot 11, however, is usually not in use because the functions of many peripheral devices are built in the notebook computer 10.

In Taiwanese Patent Publication No. M242,791, entitled “Wireless remote controller to be stored in a PCMCIA slot of a notebook computer”, a card-type wireless remote controller 12 capable of being stored in the PCMCIA slot 11 of the notebook computer 10 was disclosed. The wireless remote controller 12 has three buttons “Page Up”, “Page Down” and “Escape” for the user to navigate through the document displayed on the screen of the notebook computer 10, and a laser indication module 121 for implementing a laser beam indication function. This wireless remote controller 12, however, still has several drawbacks. For example, power required for the wireless remote controller 12 is supplied from a small-sized battery (not shown). Since operations of the wireless remote controller 12 and laser indication module 121 are very power-consuming devices, the battery should be frequently replaced and thus the operating cost is increased. Furthermore, the on-screen page up/page down function provided by this card-type wireless remote controller 12 is usually insufficient. In other words, the wireless remote controller 12 lacks for some common control functions such as cursor control, multimedia control and the like.

In views of the above-described disadvantages resulted from the prior art, the applicant keeps on carving unflaggingly to develop a wireless remote control device for use with a portable computer according to the present invention through wholehearted experience and research.

### SUMMARY OF THE INVENTION

It is an object of the present invention to provide a wireless remote control device capable of being charged via a PC-card slot.

Another object of the present invention is to provide a wireless remote control device having a function of controlling a computer cursor and capable of being stored in a PC-card slot.

In accordance with a first aspect of the present invention, there is provided a wireless remote control device for use with a portable computer. The wireless remote control device has a PC-slot therein. The wireless remote control device comprises a housing, a power connector, a rechargeable battery, a charging circuit, a button device and a wireless remote control main circuit. The housing has a size smaller than the PC-card slot of the personal computer to be inserted into the PC-card slot. The power connector is disposed at one end of the housing and electrically connected to a socket of the PC-card slot when the housing is inserted into the PC-card slot. The rechargeable battery is disposed in the housing. The charging circuit is disposed in the housing and electrically connected to the power connector and the rechargeable battery for charging the rechargeable battery with the electricity obtained from the portable computer via the power connector. The button device is disposed outside the housing to be actuated by a user. The wireless remote control main circuit is electrically connected to the button device and the rechargeable battery for generating wireless signals to control the portable computer in response to user's actuation with the rechargeable battery serving as a power supply.

In an embodiment, the power connector 221 is a standard 68-pin PC-card connector, and pin Nos. 17 and 51 are used as power pins.

In an embodiment, the rechargeable battery is a coin-type rechargeable lithium battery.

In an embodiment, the button device comprises a plurality of buttons and a force sensor resistance pointer control instruction generation device. The buttons are used for generating corresponding multimedia control instructions in response to user's actuation. The multimedia control instructions are further converted to into wireless signals by the wireless remote control main circuit. The force sensor resistance pointer control instruction generation device is used for generating corresponding pointer control instructions in response to user's actuation. The pointer control instructions are further converted to into wireless signals by the wireless remote control main circuit.

In an embodiment, the wireless remote control main circuit comprises a micro controller and a wireless signal transmission module. The micro controller is electrically connected to the button device and the rechargeable battery for generating corresponding control signals in response to user's actuation with the rechargeable battery serving as a power supply. The wireless signal transmission module is electrically connected to the micro controller for converting the control signals into the wireless signals.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a notebook computer and a conventional wireless controller used with the notebook computer;

FIG. 2 is a schematic functional block diagram illustrating a wireless remote control device according to a preferred embodiment of the present invention;

FIG. 3 is a schematic functional block diagram illustrating implementation of the button device and the wireless remote control main circuit shown in FIG. 2;

FIGS. 4(a) and 4(b) schematically illustrate a wireless receiver stored in the housing of the wireless remote control device; and

FIG. 5 is a schematic functional block diagram for implementing an automatic power-off function.

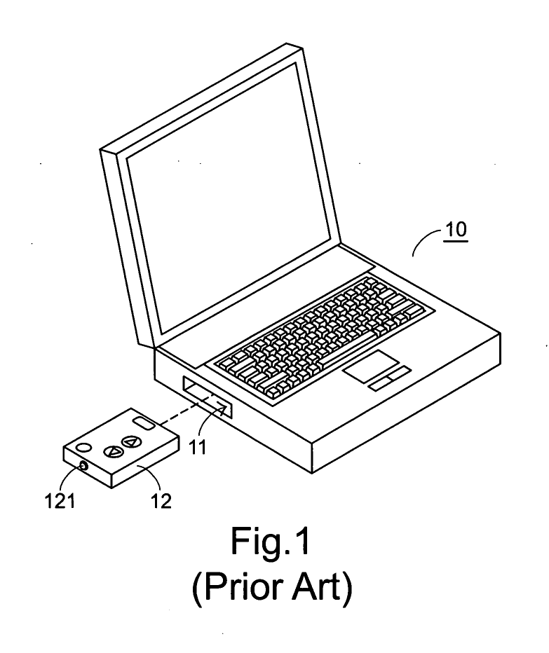

### DETAILED DESCRIPTION OF THE PREFERRED EMBODIMENT

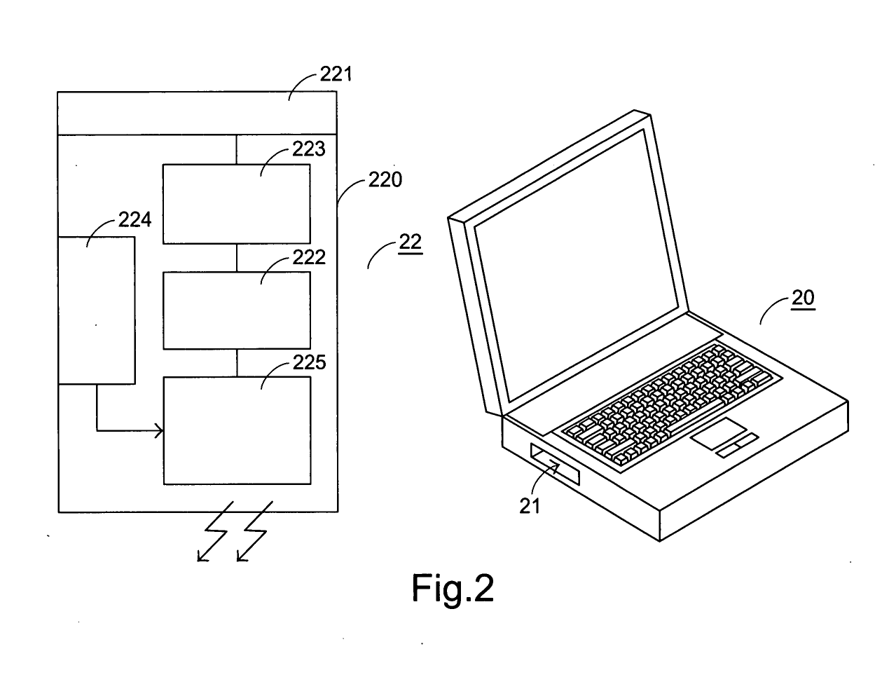

Referring to FIG. 2, a schematic functional block diagram of a wireless remote control device according to a preferred embodiment of the present invention is illustrated. The wireless remote control device 22 has both of the pointer control function and the multimedia control function, and is mainly used with a portable computer 20. The portable computer 20 includes at least a PC-card slot 21. The wireless remote control device 22 of this embodiment principally comprises a housing 220, a power connector 221, a chargeable battery 222, a charging circuit 223, a button device 224 and a wireless remote control main circuit 225. The housing 220 has a size smaller than the PC-card slot 21 but conforming to the thickness of the type II PC card specification such that the housing 220 can be accommodated within the PC-card slot 21. The button device 224 is disposed outside the housing 220 to be actuated by a user. In response to user's actuation on the button device 224, the wireless remote control main circuit 225 generates a corresponding wireless signal to control the portable computer 20. In accordance with a first feature of the present invention, the power connector 221, the chargeable battery 222 and the charging circuit 223 are included in the wireless remote control device 22. An example of the power connector 221 is a standard 68-pin PC-card connector, which is electrically connected to the portable computer 20 when inserted into the PC-card slot 21. According to the pin assignment of the 68-pin PC-card connector, pin Nos. 17 and 51 are used as power pins. Whereas, pin Nos. 34 and 68 are used as ground pins. The charging circuit 223 is electrically connected to the power connector 221 and the chargeable battery 222. Via the power connector 221, the charging circuit 223 may charge the chargeable battery 222 with the electricity obtained from the portable computer 20. In such way, when the wireless remote control device 22 of the present invention is accommodated within the PC-card slot 21, the wireless remote control device 22 will be charged.

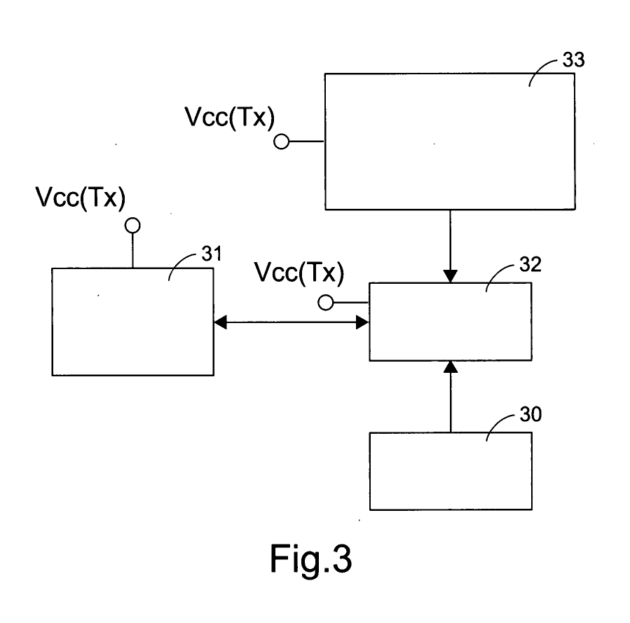

Please refer to FIG. 3, which is a schematic functional block diagram illustrating implementation of the button device 224 and the wireless remote control main circuit 225 as shown in FIG. 2. The button device 224 is disposed outside the housing 220 to be actuated by a user, and comprises two parts. The first part of the button device 224 comprises a button array 30 and a force sensor resistance (FSR) pointer control instruction generation device 33. The button array 30 consists of a plurality of buttons. In response to user's actuation on the button array 30, the micro controller 32 generates corresponding multimedia control instructions to the wireless signal transmission module 31. Examples of the multimedia control instructions include the instructions associated with volume up, volume down, previous section, next section, mute, play, pause, stop and so on. By means of the wireless signal transmission module 31, these multimedia control instructions are converted into wireless signals to control multimedia broadcast of the portable computer 20. On the other hand, in response to user's actuation on the FSR pointer control instruction generation device 33, the micro controller 32 generates corresponding pointer control instructions to the wireless signal transmission module 31. Examples of the pointer control instructions include the instructions associated with upward, downward, leftward and rightward movement of the cursor. Likewise, by means of the wireless signal transmission module 31, these multimedia control instructions are converted into wireless signals to control presentation function of the portable computer 20. By the way, the symbols Vcc(Tx) indicated in the figure means that power is supplied to the micro controller 32, the wireless signal transmission module 31 and the FSR pointer control instruction generation device 33.

Especially, the wireless remote control device 22 of the present invention further comprises a wireless receiver to be communicated with the portable computer according to the established wireless transmission protocol. For example, the wireless receiver is an external receiver coupled to the connection port of the portable computer. Alternatively, the wireless receiver is a built-in receiver arranged within the portable computer.

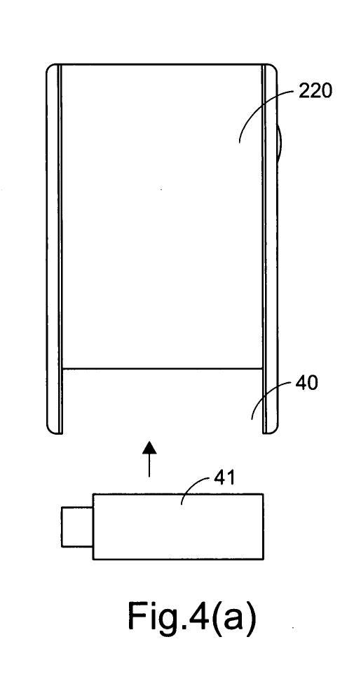

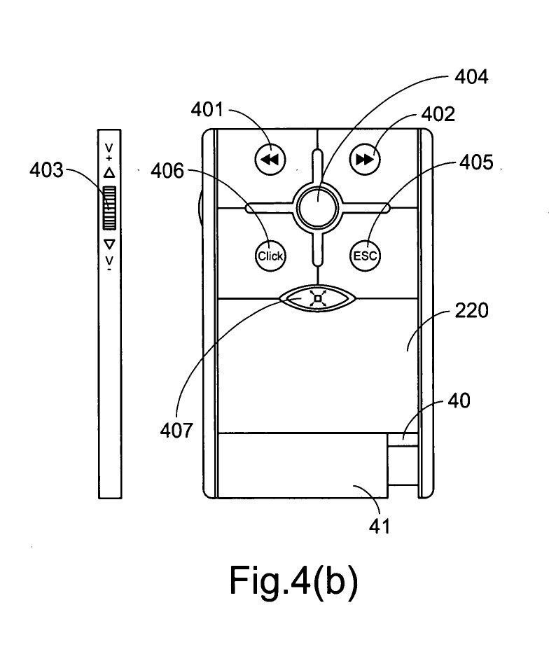

In a case that an external receiver is used, the wireless remote control device of the present invention provides a mechanism for storing this wireless receiver. Please refer to FIGS. 4(a) and 4(b), which schematically illustrate a wireless receiver stored in the housing of the wireless remote control device. A side of the housing 220 has a receptacle 40 for accommodating a wireless receiver 41. The wireless receiver 41 is detachable from the housing 220. When the wireless receiver 41 is plugged in the portable computer 20, the wireless signals from the wireless signal transmission module 31 will be transmitted to the wireless receiver 41 so as to control the portable computer 20. The wireless receiver 41 can be connected to the portable computer 20 via a universal serial bus (USB). Since the FSR pointer control instruction generation device 33 and many multimedia control buttons are arranged on the housing 220 for performing pointer control and multimedia control, the wireless remote control device of the present invention has advantages of less power-consumption, small size and functional integrity. The layout configuration of the buttons shown in the figure will be described in more details. The button 401 is actuated to implement the “Previous section” function in the multimedia control mode, or actuated to implement the “Page up” function in the pointer control and presentation mode. The button 402 is actuated to implement the “Next section” function in the multimedia control mode, or actuated to implement the “Page down” function in the pointer control and presentation mode. The knob button 403 is actuated to implement the “Mute” function in the multimedia control mode, or actuated to implement the “Middle alignment” function in the pointer control and presentation mode. The knob button 403 is rotated upwardly to increase volume (Volume up) or decrease volume (Volume down) in the multimedia control mode. Whereas, in the pointer control and presentation mode, the knob button 403 is rotated upwardly and downwardly to implement the “Scroll up” and “Scroll down” functions, respectively. The button 404 is a FSR pointer controller capable of being actuated in four directions. In the multimedia control mode, the button 404 is actuated in these four directions to implement the “Volume up”, “Volume down”, “Previous section” and “Next section” functions, respectively. Whereas, in the pointer control and presentation mode, the button 404 is actuated in these four directions to control movements of the mouse cursor, respectively. The button 405 is actuated to implement the “Stop” function in the multimedia control mode, or actuated to implement the “ESC/Right” function in the pointer control and presentation mode. The button 406 is actuated to implement the “Play/Pause” function in the multimedia control mode, or actuated to implement the “Click/Left” function in the pointer control and presentation mode. The button 407 is actuated to implement the “Function key” function in the multimedia control mode, or actuated to implement the “F5 function key” function in the pointer control and presentation mode.

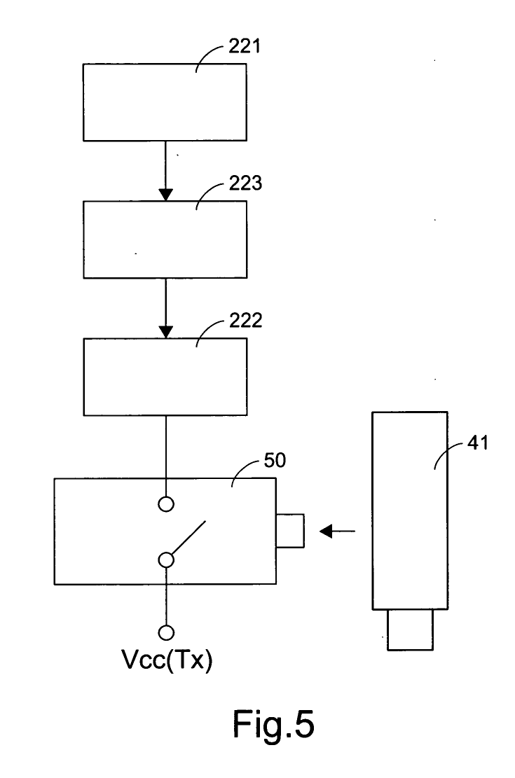

FIG. 5 is a schematic functional block diagram for implementing an automatic power-off function. In an embodiment, a micro switch 50 is arranged in the receptacle 40 as shown in FIGS. 4(a) and 4(b). Once the wireless receiver 41 is stored in the receptacle 40, the micro switch 50 is shut off. In this circumstance, the power Vcc(Tx) supplied to the micro controller 32, the wireless signal transmission module 31 and the FSR pointer control instruction generation device 33 is also interrupted in order to save power consumption.

By the way, in a case that a wireless signal transceiver module such as a Bluetooth signal processing module is embedded in the portable computer, no additional wireless receiver 41 is required.

From the above description, the slim-type wireless remote control device of the present invention conforms to a PC-card slot of a portable computer and has an automatic charging function. In addition, since the FSR pointer control instruction generation device and many multimedia control buttons are arranged on the housing for performing pointer control and multimedia control, the wireless remote control device of the present invention has advantages of less power-consumption, small size and functional integrity.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A wireless remote control device for use with a portable computer, said wireless remote control device having a PC-slot therein, said wireless remote control device comprising:
a housing having a size smaller than said PC-card slot of said personal computer to be inserted into said PC-card slot;
a power connector disposed at one end of said housing and electrically connected to a socket of said PC-card slot when said housing is inserted into said PC-card slot;
a rechargeable battery disposed in the housing;
a charging circuit disposed in said housing and electrically connected to said power connector and said rechargeable battery for charging said rechargeable battery with the electricity obtained from said portable computer via said power connector;
a button device disposed outside said housing to be actuated by a user; and
a wireless remote control main circuit electrically connected to said button device and said rechargeable battery for generating wireless signals to control said portable computer in response to user's actuation with said rechargeable battery serving as a power supply.

2. The wireless remote control device according to claim 1 wherein said power connector 221 is a standard 68-pin PC-card connector, and pin Nos. 17 and 51 are used as power pins.

3. The wireless remote control device according to claim 1 wherein said rechargeable battery is a coin-type rechargeable lithium battery.

4. The wireless remote control device according to claim 1 wherein said button device comprises:
a plurality of buttons for generating corresponding multimedia control instructions in response to user's actuation, wherein said multimedia control instructions are further converted to into wireless signals by said wireless remote control main circuit; and
a force sensor resistance pointer control instruction generation device for generating corresponding pointer control instructions in response to user's actuation, wherein said pointer control instructions are further converted to into wireless signals by said wireless remote control main circuit.

5. The wireless remote control device according to claim 1 wherein said wireless remote control main circuit comprises:
a micro controller electrically connected to said button device and said rechargeable battery for generating corresponding control signals in response to user's actuation with said rechargeable battery serving as a power supply; and
a wireless signal transmission module electrically connected to said micro controller for converting said control signals into said wireless signals.

6. A wireless remote control device for use with a portable computer, said wireless remote control device having a PC-slot therein, said wireless remote control device comprising:
a housing having a size smaller than said PC-card slot of said personal computer to be inserted into said PC-card slot;
a power connector disposed at one end of said housing and electrically connected to a socket of said PC-card slot when said housing is inserted into said PC-card slot;
a battery disposed in the housing;
a button device disposed outside said housing to be actuated by a user, comprising a force sensor resistance pointer control instruction generation device for generating corresponding pointer control instructions in response to the user's actuation; and
a wireless remote control main circuit electrically connected to said button device and said battery for generating wireless signals to control said portable computer in response to the user's actuation.
